(19) United States
(12) Patent Application Publication
(10) Pub. No.: US 2013/0176159 A1
(43) Pub. Date: Jul. 11, 2013

(54) ONE-WAY REMOTE CONTROL TRANSMITTER CAPABLE OF MEMORIZING LAST BUTTON PUSHED

(71) Applicant: Tse Hsing CHEN, New Taipei City (TW)

(72) Inventor: Tse Hsing CHEN, New Taipei City (TW)

(21) Appl. No.: 13/344,862

(22) Filed: Jan. 6, 2012

(51) Int. Cl. H04L 17/02

(52) U.S. Cl. 341/176

(57) ABSTRACT

A one-way remote control transmitter capable of memorizing last button pushed includes a button circuit for activating or deactivating an anti-theft system; an encoding circuit electrically connected to the button circuit for encoding a remote control code; an emitter circuit electrically connected to the encoding circuit for transmitting the remote control code to remotely control a main unit of the anti-theft system; a display electrically connected to the encoding circuit for displaying an operating state of the one-way remote control transmitter; a memory unit electrically connected to the encoding circuit for memorizing a button of the button circuit pushed last time; and a battery for supplying power needed by the one-way remote control transmitter to work normally. A selected button of the button circuit serves as a last-button-pushed display button that can be pushed to read the memory unit and show the last button pushed via the display.

### FIELD OF THE INVENTION

The present invention relates to a one-way remote control transmitter, and more particularly to a one-way remote control transmitter capable of memorizing last button pushed and showing the latter via a display.

### BACKGROUND OF THE INVENTION

The currently available car anti-theft system can be activated or deactivated using a hand-operated remote control transmitter. When the remote control transmitter emits a signal, a receiver module of the anti-theft system installed in the car receives the signal and actuates a control module to activate or deactivate the anti-theft system.

Most of the early-stage car anti-theft systems can only be activated or deactivated with a one-way remote control transmitter. FIG. 5 is a block diagram of a conventional one-way remote control transmitter, which mainly includes a button circuit, an encoding circuit, an emitter circuit, a light-emitting diode (LED), and a battery. With the above design, the LED can only have a simple function of displaying whether the remote control transmitter is powered or operates in a normal state. A user could not know from the LED whether a correct button on the remote control transmitter has been pushed to activate the anti-theft system. There are chances a button is wrongly or unexpectedly pushed and the anti-theft system is not activated to work normally while the user is not aware of such situation, rendering the car to the risk of being stolen.

For a user to know the exact operating state of the anti-theft system, a two-way remote control transmitter has been developed for some advanced anti-theft systems. The two-way remote control transmitter held by the user can advantageously emit sound via a buzzer or emit light via an LED or a liquid crystal display (LCD) when the anti-theft system is remotely activated or deactivated, or emits sound to alarm. However, the anti-theft system must also include a two-way receiver on the car to work with the two-way remote control transmitter. Therefore, the conventional anti-theft system with two-way receiver and two-way remote control transmitter requires a manufacturing cost about 3 to 6 times as high as the cost of the anti-theft system with a one-way remote control transmitter. Moreover, the two-way remote control transmitter consumes more power, and the battery thereof has a service life only about 20 to 30% of the battery for the one-way remote control transmitter. The two-way remote control transmitter also has an increased volume and could not be conveniently carried about compared to the one-way remote control transmitter.

### SUMMARY OF THE INVENTION

It is therefore a primary object of the present invention to provide a one-way remote control transmitter capable of memorizing last button pushed, so as to eliminate the drawbacks in the prior art one-way and two-way remote control transmitter.

To achieve the above and other objects, the one-way remote control transmitter capable of memorizing last button pushed according to the present invention includes a button circuit for activating or deactivating an anti-theft system; an encoding circuit electrically connected to the button circuit for encoding and providing a remote control code; an emitter circuit electrically connected to the encoding circuit for transmitting the remote control code to remotely control a main unit of the anti-theft system; a display being an LED indicator or an LCD panel electrically connected to the encoding circuit for displaying an operating state of the one-way remote control transmitter; a memory unit electrically connected to the encoding circuit for memorizing a button of the button circuit pushed last time; and a battery for supplying power needed by the one-way remote control transmitter to work.

With the above arrangements, one or more buttons of the button circuit can be selected to serve as a last-button-pushed display button, which can be pushed in a preset manner to read the memory unit and show the button pushed last time on the display.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a one-way remote control transmitter according to the present invention;

FIG. 2 is a schematic front view of the one-way remote control transmitter of the present invention according to a first embodiment thereof;

FIG. 3 is a schematic front view of the one-way remote control transmitter of the present invention according to a second embodiment thereof;

FIG. 4 is a schematic front view of the one-way remote control transmitter of the present invention according to a third embodiment thereof; and

FIG. 5 is a block diagram of a conventional one-way remote control transmitter.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

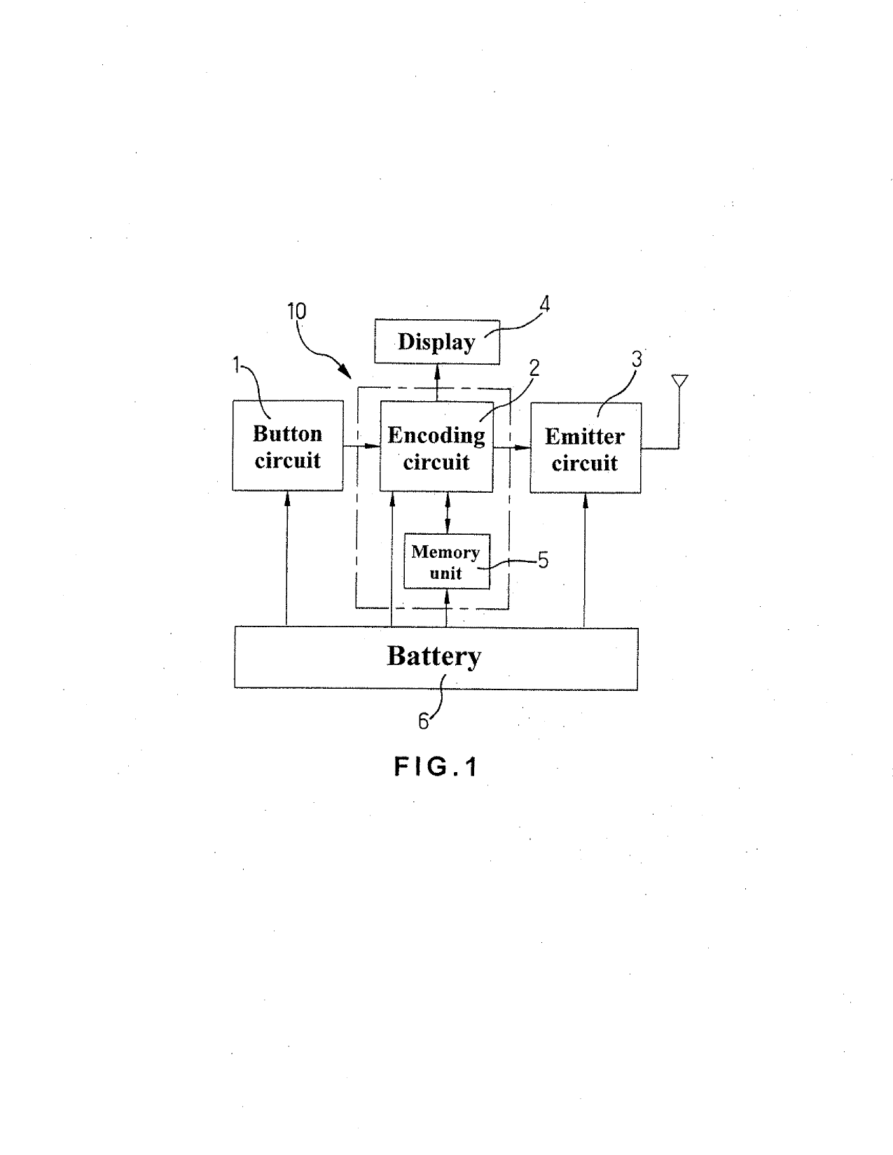

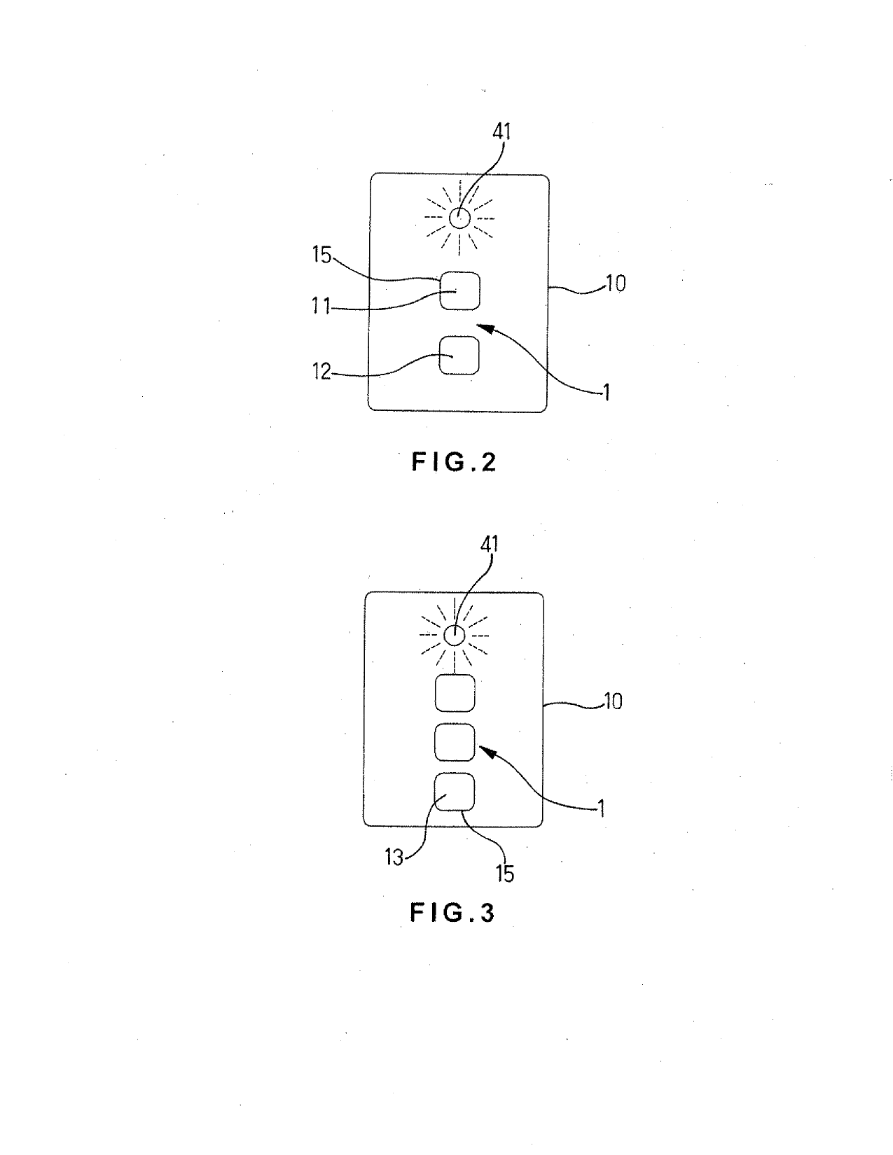

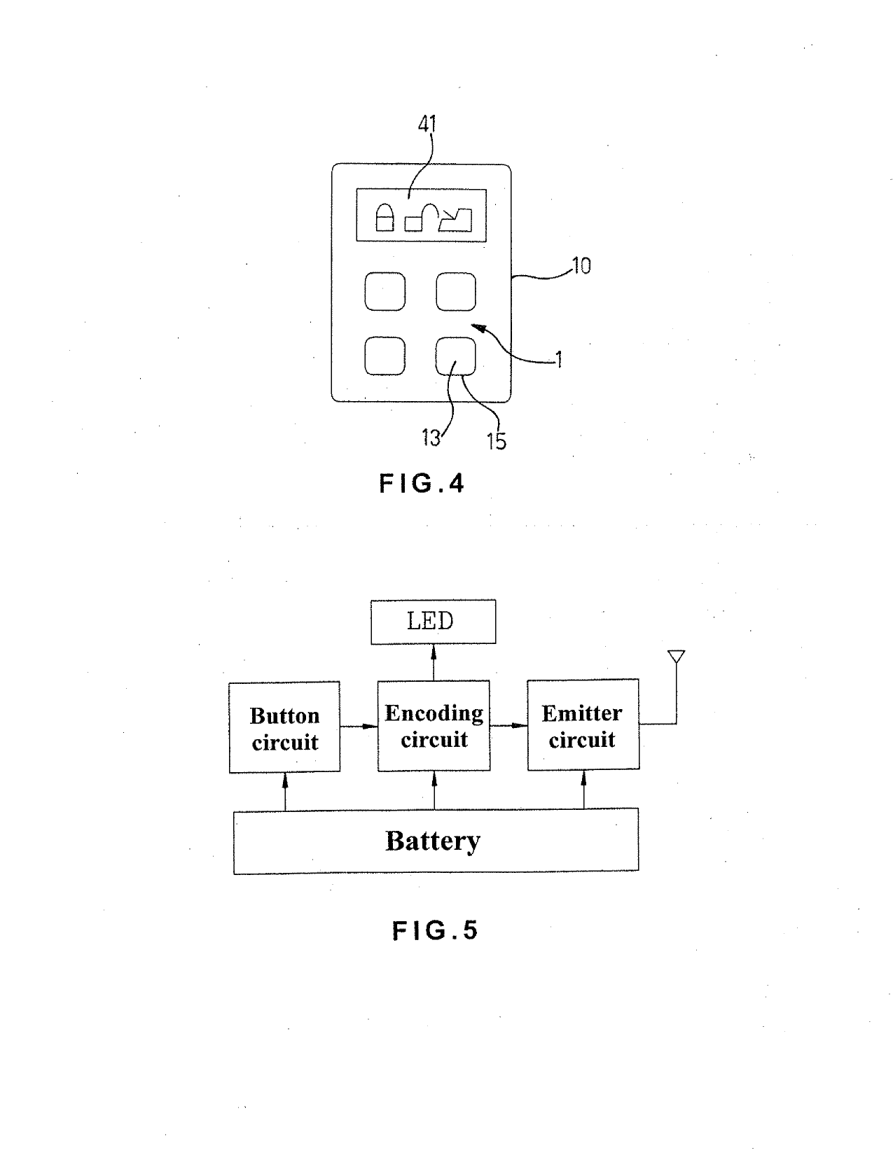

Please refer to FIG. 1 that is a block diagram of a one-way remote control transmitter 10 according to the present invention. As shown, the one-way remote control transmitter 10 mainly includes a button circuit 1 for activating or deactivating an anti-theft system (not shown); an encoding circuit 2 being a central processing unit (CPU) or an encoding integrated circuit (IC) electrically connected to the button circuit 1 for encoding and providing a remote control code; an emitter circuit 3 electrically connected to the encoding circuit 2 for transmitting the remote control code to remotely control a main unit (not shown) of the antitheft system; a display 4 being a light-emitting diode (LED) indicator 41 as shown in FIGS. 2 and 3, a liquid crystal display (LCD) panel 42 as shown in FIG. 4, or other display elements electrically connected to the encoding circuit 2 for displaying a power supply and operating state of the one-way remote control transmitter 10; a memory unit 5 being a separate memory electrically connected to the encoding circuit 2 or a memory built in the encoding circuit 2 for memorizing a button of the button circuit 1 that is pushed last time; and a battery 6 for supplying power needed by all circuits and components of the one-way remote control transmitter to work normally.

According to a first embodiment of the present invention as shown in FIG. 2, the button circuit 1 includes a button 11 selected to serve as a last-button-pushed display button 15. For example, the button 15 can be pushed once, or quickly pushed several times, or pushed and held down for a longer time to read the memory unit 5. Or, two button 11, 12 can be selected to together serve as the last-button-pushed display button 15. In this case, for example, the two buttons 11, 12 can be pushed simultaneously or sequentially to read the memory unit 5. Alternatively, according to a second embodiment of the present invention as shown in FIG. 3, the button circuit 1 may include a particular button 13 to serve as the last-button-pushed display button 15.

When using the one-way remote control transmitter 10, a user may push the last-button-pushed display button 15 in a preset manner to read the memory unit 5 via the encoding circuit 2, so that the last operating state of the button circuit 1 is displayed by the display 4. In the first and the second embodiment of the present invention as shown in FIGS. 2 and 3, respectively, the display 4 includes an LED indicator 41 that flashes in a different manner to indicate each of different button that was pushed last time. For example, when the last button pushed is an anti-theft system activating button, the push of the button 15 in the preset manner later will cause the LED indicator 41 to flash once; and when the last button pushed is an anti-theft system deactivating button, the push of the button 15 in the preset manner later will cause the LED indicator 41 to flash twice. Of course, it is also possible for the LED indicator 41 to flash in other different manners to indicate the last button pushed. In a third embodiment of the present invention as shown in FIG. 4, the display 4 includes an LCD panel 42. In this case, the last operating state of the button circuit 1, that is, the last button pushed, can be displayed on the LCD panel 42 by words, patterns, symbols, or other flashing manners.

With the above structural design of the one-way remote control transmitter 10 according to the present invention, a user can simply push the last-button-pushed display button 15 at any time to clearly know the current state of the anti-theft system set via the button circuit 1, no matter whether the buttons of the button circuit 1 are wrongly pushed, unexpectedly pushed, or not pushed at all. Therefore, the drawbacks in the conventional one-way and two-way remote control transmitter can be overcome or eliminated to ensure that the user's car anti-theft system has been effectively activated without the risk of being stolen.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A one-way remote control transmitter capable of memorizing last button pushed, comprising:
a button circuit for activating or deactivating an anti-theft system;
an encoding circuit being electrically connected to the button circuit for encoding and providing a remote control code;
an emitter circuit being electrically connected to the encoding circuit for transmitting the remote control code to remotely control a main unit of the anti-theft system;
a display being electrically connected to the encoding circuit for displaying an operating state of the one-way remote control transmitter;
a memory unit being electrically connected to the encoding circuit for memorizing a button of the button circuit that is pushed last time; and
a battery for supplying power needed by all circuits and components of the one-way remote control transmitter to work normally.

2. The one-way remote control transmitter as claimed in claim 1, wherein the display is selected from the group consisting of a light-emitting diode (LED) indicator and a liquid crystal display (LCD) panel.

3. The one-way remote control transmitter as claimed in claim 1, wherein the memory unit is built in the encoding circuit.

4. The one-way remote control transmitter as claimed in claim 1, wherein the memory unit is a separate memory.

5. The one-way remote control transmitter as claimed in claim 1, wherein the encoding circuit is selected from the group consisting of a central processing unit (CPU) and an encoding integrated circuit (IC).

6. The one-way remote control transmitter as claimed in claim 1, wherein the button circuit includes a selected button to serve as a last-button-pushed display button; the last-button-pushed display button being able to read the memory unit when being pushed in a preset manner; and the preset pushing manner being selected from the group consisting of pushing the button once, quickly pushing the button several times, and pushing and holding down the button for a period of time.

7. The one-way remote control transmitter as claimed in claim 1, wherein the button circuit includes two selected buttons to together serve as a last-button-pushed display button; the last-button-pushed display button being able to read the memory unit when the two selected buttons are pushed in a preset manner; and the preset pushing manner being selected from the group consisting of pushing the two buttons simultaneously and pushing the two buttons sequentially.

8. The one-way remote control transmitter as claimed in claim 1, wherein the button circuit includes a particular button to serve as a last-button-pushed display button.
